(19) United States
(12) Patent Application Publication
(10) Pub. No.: US 2003/0135572 A1
(43) Pub. Date: Jul. 17, 2003

(54) Portable data terminal

(76) Inventor: Nobuyuki Katada, Tokyo (JP)

Correspondence Address: OSTROLENK FABER GERB & SOFFEN, 1180 AVENUE OF THE AMERICAS, NEW YORK, NY, 100368403

(21) Appl. No.: 10/337,197

(22) Filed: Jan. 3, 2003

(30) Foreign Application Priority Data
Jan. 8, 2002 (JP) 001014/2002
Nov. 8, 2002 (JP) 324846/2002

(51) Int. Cl. G06F 15/16

(52) U.S. Cl. 709/206

(57) ABSTRACT

The portable data terminal has a memory unit 14, an operation unit 16 and a display unit 17, these units being controlled by a control unit 13, and displays received (or transmitted) mails as a received (or transmitted) mail list 20A on the display unit 17. The user operates the operation unit 15 to permit selection of mails concerning a particular sender (or destination) among received (or transmitted) mails stored in the memory unit 14, extraction of the concerning mails and display of the extracted mails as a mail list for individual senders (or destinations). The portable data terminal improves the operability of simply and quickly doing a retrieval operation when a list of transmitted and received mails is displayed.

### BACKGROUND OF THE INVENTION

This application claims benefit of Japanese Patent Applications Nos. 2002-001014 and 2002-324846 filed on Jan. 8, 2002 and Nov. 8, 2002, respectively, the contents of which are incorporated by the reference.

The present invention relates to portable data terminals and, more particularly, to portable data terminals having a display unit for displaying transmitted and received electronic mails.

With the progress of semiconductor integrated circuit techniques, communication techniques and display device techniques, portable telephone sets are in a trend of being progressively smaller in size, more and more advanced in performance and progressively cheaper in price. Consequently, the spread of portable telephone sets is rapid and so powerful as to surpass non-movable or stationary telephone sets. Portable telephone sets do not only serve as mere communication means, but those which are internet connected and serve as terminal for electronic mail communication or data retrieval have been developed and in practical use.

Prior art examples in or related to such technical field are Japanese Patent Laid-Open No. 2000-222301 entitled “Server, Mail Data Conversion Method and Recording Medium”, Japanese Patent Laid-Open No. 2000-30586 entitled “Data Storage System”, Japanese Patent Laid-Open No. 2001-216220 entitled “Electronic Mail System and Electronic Mail Processing Method”, Japanese Patent Laid-Open No. 7-134680 entitled “Electronic Mail System”, Japanese Patent Laid-Open No. 10-257090 entitled “Server for Electronic Mails and Portable Terminal System”, Japanese Patent Laid-Open No. 11-85648 entitled “Received Data Processing Method, Data Communication Processing System, Data Communication Method, Data Communication System, Data Communication Terminal and Server System” and Japanese Patent Laid-Open NO. 8-139747 entitled “Radio Electronic Mail Receiving System”. Among these techniques, there are data communication terminals, which, for grasping rough received data contents (summary) at a glance of a received data list, the contents of specific received data selected from among own-addressed received data displayed on a display screen, are developed to a display frame for contents confirmation. Typical examples of such data communication terminal are disclosed in, for instance, Japanese Patent Laid-Open No. 11-85648 (page 13, FIG. 8).

Portable data terminals typically portable telephone sets have a function of displaying received or transmitted electronic mails by list display for the user's convenience. In the usual electronic mail list display, for instance in the case of a received mail list, such state display or display items as the reception date and time, the case title and the read or non-read case is provided. Beside the list display, the number of received mail cases, the number of non-read mails, the number of protected (or preserved) mails, etc. are displayed. When a mail is selected and certified, detailed header data such as the mail reception date and time and the sender of mail are displayed in addition to the mail text. Furthermore, it is possible to display, protect or delete the sole read or non-read mails by a predetermined operation of an operation unit (such as the depression of an operation key).

The prior art techniques described above, however, pose some problems to be solved as follows.

In the first place, when a mail list or like data is displayed on the display screen of a portable telephone set, no data concerning a single received mail on cursor is displayed on any area of the display unit other than the list display. Since the list display provides only the date and time and the case title, data concerning the mail sender on cursor and whether any other mail has been received from that sender are not known until the sole mails from that sender have been extracted and observed. Likewise, in the case of the transmitted mail list display, data concerning the destination of the mail on the cursor and whether any other mail transmitted to that destination are not known until the sole mails addressed to the mail destination are extracted and observed.

Secondly, when extracting sole received mails from a particular sender or sole transmitted mails to a particular destination after mail list display on the display screen, the full received or transmitted mails may sometimes not be displayed on a single display frame. In such a case, by moving the cursor for retrieval the display is progressively moved downward by the row scrawl. However, the number of extracted cases and the order of mail on the cursor are not known.

Thirdly, when the desired sender or the destination for retrieval is specified, a series of operations of displaying a received or transmitted mail list on the display screen and further moving the cursor to the specified sender or destination has to be made. This series of operations, however, is cumbersome and requires relatively long time while the user is moving (for instance, walking).

### SUMMARY OF THE INVENTION

The present invention was made in view of the above problems inherent in the prior art, and it has an object of providing a portable data terminal capable of improving function of retrieving for mails received from a particular sender or mails transmitted to a particular destination and displaying these mails.

According to an aspect of the present invention, there is provided a portable data terminal for storing transmitted and received electronic mails and displaying the stored electronic mails on a display unit, wherein: electronic mails concerning particular electronic mails selected from among the stored electronic mails and also the total number of all cases of the concerning electronic mails are displayed at the same time.

The concerning electronic mails are electronic mails from the same sender. The concerning electronic mails are electronic mails addressed to the same destination. The concerning electronic mails are displayed in a color of display or a fashion different from the other electronic mails during the electronic mail list display. The sole concerning electronic mails are extracted and displayed on the display unit. The particular electronic mails are designated and selected by the user by using cursor. A particular address is designated with reference to an address directory, in which electronic mail addresses are stored.

According to another aspect of the present invention, there is provided a portable data terminal having functions of transmitting and receiving electronic mails as well as displaying transmitted and received electronic mails on a display unit and storing these electronic mails in a memory unit, wherein: sole electronic mails from a designated particular electronic mail sender among the received electronic mails are displayed on the display unit.

The sole electronic mails from the designated particular electronic mail sender are displayed on the display unit after the lapse of a predetermined time in the received electronic mail display state.

According to other aspect of the present invention, there is provided a portable data terminal having functions of transmitting and receiving electronic mails as well as displaying transmitted and received electronic mails on a display unit and storing these electronic mails in a memory unit, wherein: the electronic mails from a designated particular electronic mail sender among the received electronic mails are displayed in a color of display different from the display color of the other electronic mails.

The portable data terminal according to claim 8 or 10, wherein a display state of displaying the sole electronic mails from the particular electronic mail sender is switched over from the received electronic mail display state by a predetermined operation. The serial numbers of electronic mails from the particular electronic mail sender are displayed at the same time. The sender of the electronic mail is designated with reference to an address directory, in which electronic mail addresses are stored.

According to still other aspect of the present invention, there is provided a portable data terminal having functions of transmitting and receiving electronic mails as well as displaying transmitted and received electronic mails on a display unit and storing these electronic mails in a memory unit, wherein: sole electronic mails to a destination of a designated particular electronic mail among the transmitted electronic mails are displayed on the display unit.

The sole electronic mails to the designated particular electronic mail destination are displayed on the display unit after the lapse of a predetermined time in the transmitted electronic mail display state.

According to further aspect of the present invention, there is provided a portable data terminal having functions of transmitting and receiving electronic mails as well as displaying transmitted and received electronic mails on a display unit and storing these electronic mails in a memory unit, wherein: the electronic mails to a designated particular electronic mail destination among the transmitted electronic mails are displayed in a color of display different from the display color of the other electronic mails.

A display state of displaying the sole electronic mails to the particular electronic mail destination is switched over from the transmitted electronic mail display state by a predetermined operation. The serial numbers of electronic mails to the particular electronic mail destination are displayed at the same time. The destination of the electronic mail is designated with reference to an address directory, in which electronic mail addresses are stored. The portable data terminal is a portable telephone set.

Other objects and features will be clarified from the following description with reference to attached drawings.

### BRIEF DESCRIPTION OF THE DRAWINGS

FIG. 1 is a block diagram showing the entire construction of the portable telephone set as an example of the portable data terminal according to the present invention;

FIGS. 2(A) and 2(B) are views for describing the above various functions of the portable data terminal according to the present invention;

FIGS. 3(A) and 3(C) show display examples in a different embodiment of the portable telephone set as portable data terminal according to the present invention;

FIGS. 4(A) to 4(C) are views for describing functions of a further embodiment of the portable telephone set as portable data terminal according to the present invention;

FIGS. 5(A) to 5(C) show an example of providing a list display of sole mails to a particular destination as extracted from the transmitted mail list display; and

FIGS. 6(A) to 6(D) show an example of the case that a sender desired to be confirmed is predetermined and has been registered in an address directory.

### PREFERRED EMBODIMENTS OF THE INVENTION

Preferred embodiments of the present invention will now be described with reference to the drawings.

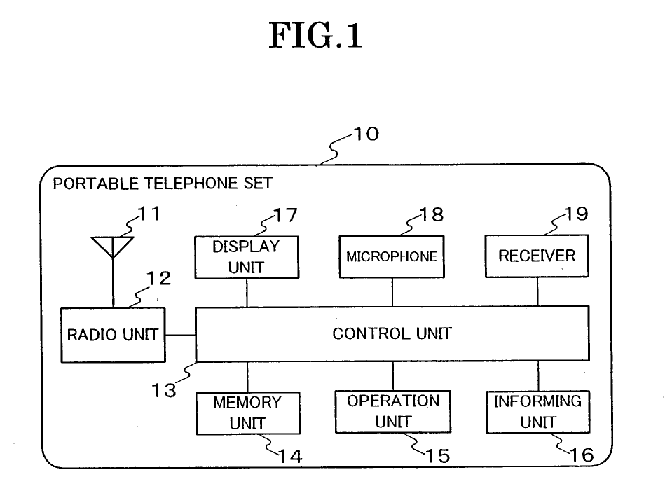

FIG. 1 is a block diagram showing the entire construction of the portable telephone set as an example of the portable data terminal according to the present invention. This portable telephone set 10 comprises an antenna 11, a radio unit 12, a control unit 13, a memory unit 14, an operation unit 15, an informing unit 16, a display unit 17, a microphone 18 and a receiver 19. The antenna 11 is connected to the radio unit 12. The radio unit 12, the memory unit 14, the operating unit 15, the informing unit 16, the display unit 17, the microphone 18 and the receiver 19 are all connected to the control unit 13.

The main functions of the unit elements of the portable telephone set 10 will be described. The antenna 11 receives communication waves as microwaves of about 1 GHz transmitted from the base station (not shown), and also transmits communication waves to the base station. The radio unit 12 transmits and receives data via the antenna 11. The control unit 13 controls all the processes in the portable telephone set 10, and it may be constituted by a microprocessor or a microcomputer. At the time of a call arrival, the informing unit 16 informs this by means of a beep tone or vibrator oscillations to the user. The microphone 18 or the receiver 19 makes voice communication when the user responds to the arrived call. The memory unit 14 preserves and stores received mail data. The operation unit 15 performs for operation of input of the telephone number of the other party for the communication and operation of electronic mail transmission and reception. The display 17 is constituted by a liquid crystal display panel, for instance, and thus displays the telephone number of communication by the portable telephone set 10, transmitted and received electronic mail data and so forth based on the operation of the operation unit 15.

As described before, the present invention concerns the list display of received and transmitted mails with respect to the contents displayed on the display unit 17. In the case of received mails, for instance, the control unit 13 provides a function of displaying the mail sender's name on a cursor line, the number of cases of received mails received from the sender and stored in the memory unit 14. In addition to the above functions, the portable data terminal (i.e., portable telephone set) 10 according to the present invention further has a function of causing, when the electronic mail list display is caused, the display of only received mails from the mail sender and only transmitted mails to the mail destination on cursor lines preset by a predetermined operation of the operation unit 15 in, for instance, a different color or colors of display as distinguished from the other received and transmitted electronic mails. Furthermore, the portable data terminal 10 according to the present invention has a function, provided at the time of causing the mail list display, of extracting and displaying, in the case of received mails, only received mails from the mail sender on the cursor line and, in the case of transmitted mails, only transmitted mails to the mail destination on the cursor line, in response to a predetermined operation of the operation unit 15. Still further, the portable data terminal 10 according to the present invention has a function, in addition to the above functions, of causing extraction and list display of only mails received from registered person on cursor or mails transmitted to registered person on cursor in response to a predetermined operation of the operation unit 15.

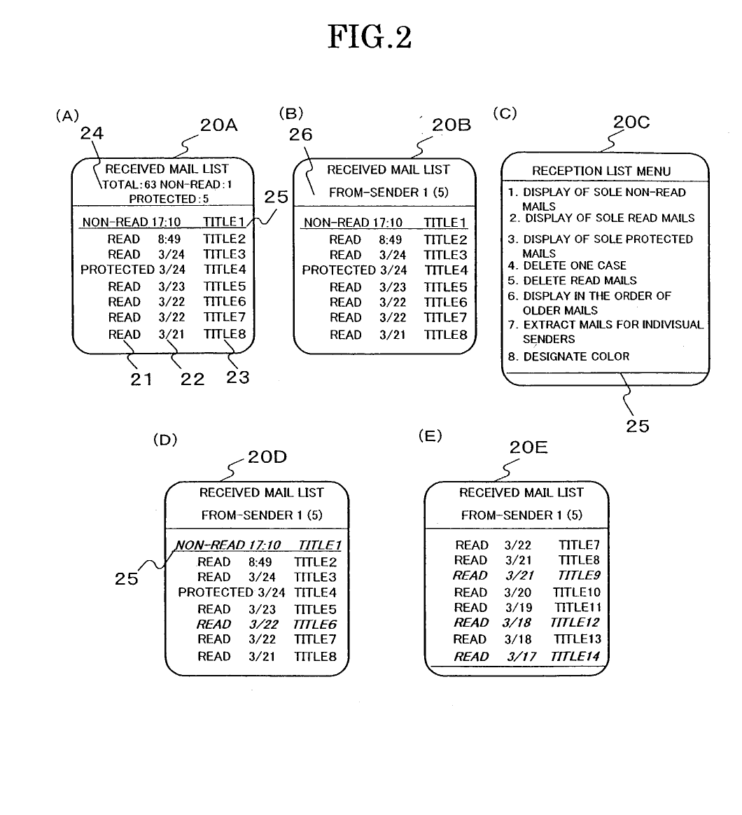

FIGS. 2(A) and 2(B) are views for describing the above various functions of the portable data terminal (i.e., portable telephone set) 10 according to the present invention. The operation of the portable telephone set 10 will now be described with reference to these Figures. While no call transmission or reception or no functional operation is in force, usually the present date and present time are displayed on the display unit 17. When it is desired to display, for instance, a received mail list from this normal state, a predetermined operation of the operation unit 15 is made, whereby display of “RECEIVED MAIL LIST” 20A as shown in FIG. 2(A) on the display unit 17 is caused. In the specific example as shown in FIG. 2 (A), mail state 21, reception date 22 and case title 23 are displayed. As for the mail state 21, read mails are labeled “READ”, non-read mails are labeled as “NON-READ”, and mails which are protected against deletion are labeled “PROTECTED”. Of course, in lieu of the character display as shown in FIG. 2(A), the display may be made with icon display or in different colors which can be readily visually understood.

As soon as the “RECEIVED MAIL LIST” 20A is displayed, a case number display 24, i.e., the total number of all cases of received mails, the number of cases of non-read received mails and the number of protected received mails, as stored in the memory unit 14, are displayed right above the “RECEIVED MAIL LIST” display.

After the lapse of a predetermined time, “RECEIVED MAIL LIST” 20B concerning a particular sender as shown in FIG. 2B is displayed. That is, the prevailing display is changed to that of electronic mail sender 26 on cursor 25 and mails (i.e., case number thereof) received from that sender. Thus, even in the case of the case name list display the sender can be readily recognized. As an alternative to automatically changing the received mail list display after a time lapse, it is possible to cause display change to the “RECEIVED MAIL LIST” 20B by a particular operation of the operation unit 15. When it is desired to confirm the contents of a particular mail during the display of the “RECEIVED MAIL LIST” 20B, the cursor 25 is moved and confirmed by a predetermined operation of the operation unit 15. As a result, the full text of the mail on the cursor 25 is displayed.

When it is desired to display in a different color of sole mails received from the mail sender on the cursor, “RECEPTION LIST MENU” 20C as shown in FIG. 2(C) is called by a predetermined operation of the operation unit 15. As a result, a menu for display content changes as shown in the Figure is displayed. This reception list menu contains items of 1: “DISPLAY OF SOLE NON-READ MAILS”, 2: “DISPLAY OF SOLE READ MAILS”, 3: “DISPLAY OF SOLE PROTECTED MAILS”, 4: “DELETE ONE CASE”, 5: “DELETE READ MAILS”, 6: “DISPLAY IN THE ORDER OF OLDER MAILS”, 7: “EXTRACT MAILS FOR INDIVIDUAL SENDERS” and 8: “DESIGNATE COLOR” (i.e., color designation). When the “DESIGNATE COLOR” is selected and confirmed, only electronic mails from a particular sender in a line specified by cursor 25 in the “RECEIVED MAIL LIST” 20D in FIG. 2(D) are displayed in a different color (see FIG. 2(E)). The user thus can readily extract only the mails from the particular sender even during the full case display. In the Figure, bold characters are used in lieu of the color display. It is of course possible to adopt any other display form than the color display as well.

In the “RECEIVED MAIL LIST” display, the electronic mails are displayed from the newest one downward from the display screen of the display unit 17. The cursor 25 is initially displayed in the uppermost part of the electronic mail position. By moving and certifying the cursor 25 to and at the electronic mail, the contents of which are desired to be displayed, by a predetermined operation of the operation unit 25. In this way, the contents of the desired electronic mail can be displayed.

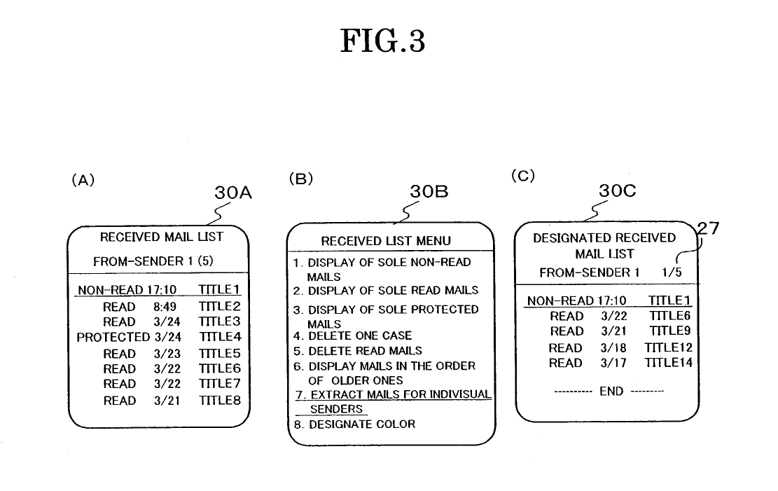

FIGS. 3(A) and 3(C) show display examples in a different embodiment of the portable telephone set as portable data terminal according to the present invention. By making a predetermined operation of the operation unit 15 in a time display state, which prevails while no operation of the portable telephone set is made, “RECEIVED MAIL LIST” 20A is displayed as described before in connection to FIG. 2 (A). As described above, this “RECEIVED MAIL LIST” 20A contains a case number display 24, i.e., display of total number of all mail cases, the non-read mail case number and the protected mail case number. Also as described above, the electronic mail sender on cursor 25, and mails (i.e., full case number) from the sender are displayed after the lapse of a predetermined time. When it is desired to extract, for the list display, the sole received mails from the mail sender on the cursor 25, a predetermined operation of the operation unit 15 is made, whereby “RECEIVED LIST MENU” 30B, i.e., a sub-menu, as shown in FIG. 3(B), is displayed. This “RECEIVED LIST MENU” 30B, like the “RECEIVED LIST MENU as shown in FIG. 2(C), contains the items of 1: “SOLE NON-READ MAIL DISPLAY”, 2: “SOLE READ MAIL DISPLAY”, 3: “SOLE PROTECTED MAIL DISPLAY”, 4: “DELETE ONE CASE”, 5: “DELETE READ MAILS”, 6, “DISPLAY MAILS IN THE ORDER OF OLDER ONES”, 7: “EXTRACT MAILS FOR INDIVIDUAL SENDERS” and 8: “COLOR DESIGNATION”.

When the item 7, i.e., “EXTRACT CASES FOR INDIVIDUAL SENDERS”, is selected and certified, as shown in FIG. 3(C), the sole received mails from the mail sender on the cursor 25 are retrieved and extracted from the memory unit 14 for case title list display. In the display of this “DESIGNATED RECEIVED MAIL LIST” 30C concerning the particular sender, the reception date and time of the extracted electronic mails are displayed from newer ones. The particular sender's name, the full extracted mail case number and the serial number of the electronic mail on the cursor, as designated together at 27, are also displayed right above the list display. The serial number of the electronic mail on the cursor can be changed by moving the cursor, thus permitting the serial number of the case on the cursor to be understood even in the case of a too large number of extracted mail cases which can not be displayed on the single screen.

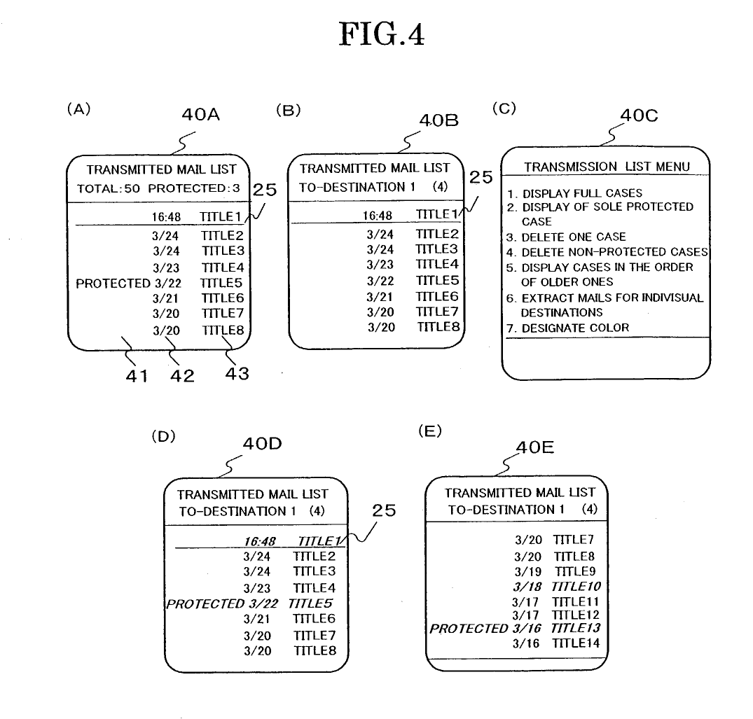

FIGS. 4(A) to 4(C) are views for describing functions of a further embodiment of the portable telephone set 10 as portable data terminal according to the present invention. The operation of the portable telephone set 10 in the case of transmitted mails will now be described with reference to the Figures.

When it is desired to display a transmitted mail list by changing the normal state, i.e., display of the present date and time, a predetermined operation of the operation unit 15 is made to cause display of “TRANSMITTED MAIL LIST” 40A shown FIG. 4(A). In the particular example shown in FIG. 4(A), mail state 41, reception date and time 42 and case title 43 are displayed. As for the mail state 41, mails which are protected against deletion are labeled “PROTECTED”.

As soon as this “TRANSMITTED MAIL LIST” 40A is displayed, a case number display, i.e., displays of the total number of all transmitted mail cases and the total number of all protected transmitted mail cases, as stored in the memory unit 14, is provided right above the transmitted mail list display. Then, after the lapse of a predetermined time, the display is changed to “TRANSMITTED MAIL LIST” 40B of a particular destination as shown in FIG. 4(B), i.e., displays of the electronic mail destination on cursor and the case number of mails transmitted to the destination. While the case title list display is automatically changed after the time lapse as in the above, it is also possible to cause display change to the “TRANSMITTED MAIL LIST” 40B by making a predetermined operation of the operation unit 15. When it is desired to confirm the contents of the particular mail from the display of the “TRANSMITTED MAIL LIST” 40B, the cursor 25 is moved and certified by making a predetermined operation of the operation unit 15. As a result, the full text of the mail on the cursor 25 is displayed.

When it is desired, during the full transmitted mail list display, to display sole mails transmitted to the destination on the cursor in a different color of display, “TRANSMISSION LIST MENU” 40C as shown in FIG. 4(C), i.e., a menu for changing the display contents, is called by making a predetermined operation of the operation unit 15. This transmission list menu contains 1: “FULL CASE DISPLAY”, 2: “SOLE PROTECTED CASE DISPLAY”, 3: “DELETE ONE CASE”, 4: “DELETE NON-PROTECTED CASES”, 5: “DISPLAY CASES IN THE ORDER OF OLDER ONES”, 6: “EXTRACT CASES FOR INDIVIDUAL DESTINATIONS” and 7: “COLOR DESIGNATION”. When the “COLOR DESIGNATION” is selected and certified, sole electronic mails to a particular destination on the line specified by the cursor 25 in the “TRANSMITTED MAIL LIST” 40D as shown in FIG. 4D are displayed in a different color of display (see FIG. 4 (E)). The user thus can readily extract the sole mails to the particular destination even during the full case display. In this Figure, however, slanted characters are used for showing because color display can not be shown. It is of course possible to adopt any other desired form of display than the color display as well.

In this “TRANSMITTED MAIL LIST” display, the electronic mails are displayed from newer date ones downward on the display screen of the display unit 17. The cursor 25 is initially displayed on the uppermost electronic mail position. By moving and certifying the cursor 25 to the electronic mail, the contents of which are desired to be displayed, by making a predetermined operation of the operation unit 15, the contents of that electronic mail can be displayed.

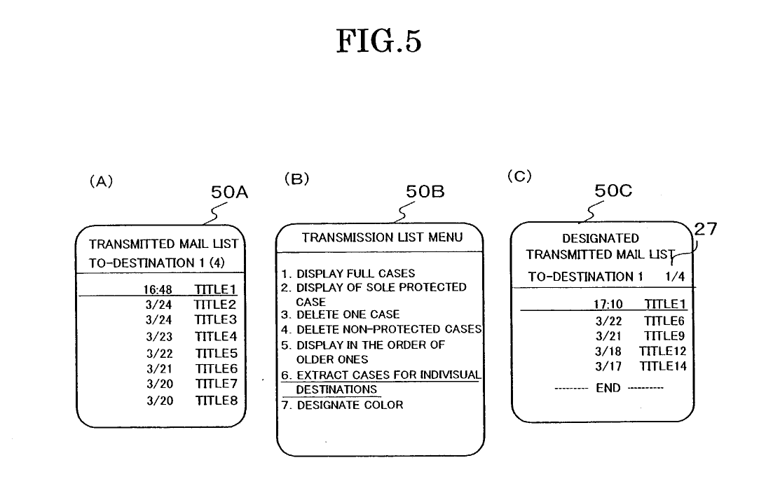

FIGS. 5(A) to 5(C) show an example of providing a list display of sole mails to a particular destination as extracted from the transmitted mail list display. By making a predetermined operation of the operation unit 15 in the time display state prevailing without making any operation of the portable telephone set, “TRANSMITTED MAIL LIST” 50A as shown in FIG. 5(A) is displayed. As described above, the “TRANSMITTED MAIL LIST” contains the electronic mail destination on cursor and the total number of all mail cases concerning the destination. When it is desired to extract, for the list display, the sole transmitted mails to the destination on the cursor, a predetermined operation of the operation unit 15 is made, whereby “TRANSMISSION LIST MENU” SOB, a sub-menu, as shown in FIG. 5(B), is displayed. This “TRANSMISSION LIST MENU”, like the “TRANSMISSION LIST MENU” 40C as shown in FIG. 4(C), contains the items of 1: CASE DISPLAY”, 2: “SOLE PROTECTED CASE DISPLAY”, 3: “DELETE ONE CASE”, 4: “DELETE NON-PROTECTED CASES”, 5: “DISPLAY CASES IN THE ORDER OF OLDER ONES”, 6: “EXTRACT CASES FOR INDIVIDUAL DESTINATIONS” and 7: “DESIGNATE COLOR”.

When the item 6, i.e., “EXTRACT CASES FOR INDIVISUAL DESTINATIONS”, is selected and certified, as shown in FIG. 5(C), the sole transmitted mails to the destination on the cursor are retrieved and certified from the memory unit 14 for case title list display. In the display of this “DESIGNATED TRANSMITTED MAIL LIST” 50C concerning the particular destination, the transmission date and time are displayed from newer ones, the total number of all cases concerning the particular destination and the serial number of the electronic mail on the cursor, as designated together at 27, are also displayed right above the list display. The serial number of the electronic mail on the cursor is changed by moving the cursor, thus permitting the serial number of the case on the cursor to be understood even in the case of a too large number of extracted mail cases which can not be displayed on the single screen.

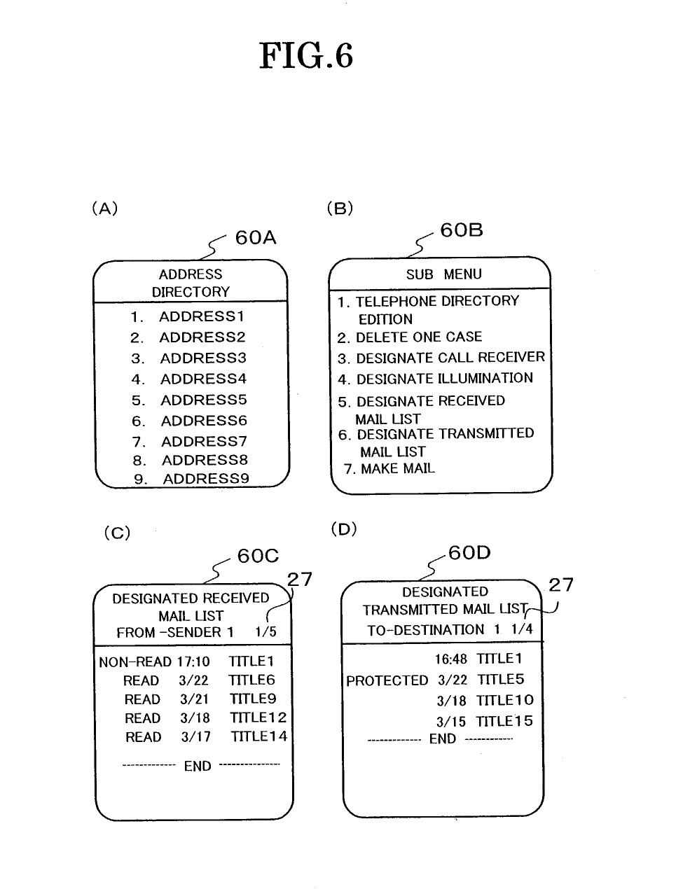

FIGS. 6(A) to 6(D) show an example of the case that a sender desired to be confirmed is predetermined and has been registered in an address directory. Specifically, in this example it is not that the sole electronic mails received from a particular sender are extracted from any mail list display, but the particular sender has been selected in advance from the address directory, and the sole electronic mails therefrom are extracted by calling a sub-menu, thereby providing the display of a received mail list. By calling the address directory in a predetermined operation of the operation unit 15 in the time display state, which prevails without any operation of the portable telephone set 10, registered “ADDRESS DIRECTORY” (or address list) 60A as shown in FIG. 6(A) is displayed.

In this state, the predetermined registered person is selected and certified by moving the cursor 25 moved with operation of the operation unit 15, whereby “SUB-MENU” 6(B) as shown in FIG. 60B is displayed. The “SUB-MENU” 60B contains 1: “TELEPHONE DIRECTORY EDITION”, 2: “DELETE ONE CASE”, 3: “DESIGNATED CALL RECEIVER”, 4: “DESIGNATED ILLUMINATION”, 5: “DESIGNATED RECEIVED MAIL LIST”, 6: “DESIGNATED TRANSMITTED MAIL LIST” and 7: “MAKE MAIL”. Then, by selecting and certifying the item 5, i.e., the “DESIGNATED RECEIVED MAIL LIST”, the sole mails received from the selected and certified sender are extracted from among the full received mails preserved in the memory unit 14, and “DESIGNATED RECEIVED MAIL LIST” 60C as shown in FIG. 6(C) is displayed. By selecting and certifying the item 6, i.e., the “DESIGNATED TRANSMITTED MAIL LIST”, the sole mails addressed to the selected and certified destination are extracted from among the full transmitted mails preserved in the memory unit 14, and “DESIGNATED TRANSMITTED MAIL LIST” 60D with serial number 27 as shown in FIG. 6(D) is displayed. Thus, it is possible to provide a list display of the sole received mails from a particular sender to be confirmed by a simple operation of retrieving the “DESIGNATED RECEIVED MAIL LIST” 60C for the electronic mails from the particular sender by moving the cursor and extracting the received mails from that sender. It is also possible to provide a list display of the sole mails addressed to a particular destination to be confirmed by retrieving the “DESIGNATED TRANSMITTED MAIL LIST” 60D for the electronic mails to the particular destination by moving the cursor and extracting the sole mails transmitted to that destination.

As has been described in the foregoing, with the portable data terminal according to the present invention the following pronounced practical effects are obtainable. In the first place, while data of, for instance, the “RECEIVED MAIL LIST” are displayed on the display screen of the display unit in the portable data terminal, the total number of mail cases stored in the memory unit 14 among the mails received from the sender on the cursor is displayed. Thus, it is possible to recognize at a glance whether any other mail has been received from the same sender or how many cases have been received therefrom. It is thus possible to greatly improve the convenience of the portable data terminal user.

Secondly, sole mails form a particular sender can be displayed by list display in a different color of display, for instance. Thus, it is possible to readily discriminate the sole mails from the same sender even during the full received mail list display. Also, the sole mails addressed to a particular destination can be displayed by list display in a different color, and it is thus possible to readily discriminate the sole mails addressed to the same destination.

Furthermore, the sole received mails from a particular sender or the sole transmitted mails to a particular destination are displayed by list display, and even in the case when the mails can not be fully displayed in one display frame, it is possible to display the order of the prevailing received or transmitted mail in the number of extracted cases. It is thus possible to grasp the number of remaining cases even during the retrieval.

In addition to the above functions, it is possible to select a particular registered person from the address directory and display the sole received or transmitted mail list concerning that registered person. Thus, it is possible to more quickly and readily display the mail list from a particular sender or to a particular destination.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A portable data terminal for storing transmitted and received electronic mails and displaying the stored electronic mails on a display unit, wherein:
electronic mails concerning particular electronic mails selected from among the stored electronic mails and also the total number of all cases of the concerning electronic mails are displayed at the same time.

2. The portable data terminal according to claim 1, wherein the concerning electronic mails are electronic mails from the same sender.

3. The portable data terminal according to claim 1, wherein the concerning electronic mails are electronic mails addressed to the same destination.

4. The portable data terminal according to claim 1, wherein the concerning electronic mails are displayed in a color of display or a fashion different from the other electronic mails during the electronic mail list display.

5. The portable data terminal according to claim 1, wherein the sole concerning electronic mails are extracted and displayed on the display unit.

6. The portable data terminal according to claim 1, wherein the particular electronic mails are designated and selected by the user by using cursor.

7. The portable data terminal according to claim 1, wherein a particular address is designated with reference to an address directory, in which electronic mail addresses are stored.

8. A portable data terminal having functions of transmitting and receiving electronic mails as well as displaying transmitted and received electronic mails on a display unit and storing these electronic mails in a memory unit, wherein:
sole electronic mails from a designated particular electronic mail sender among the received electronic mails are displayed on the display unit.

9. The portable data terminal according to claim 8, wherein the sole electronic mails from the designated particular electronic mail sender are displayed on the display unit after the lapse of a predetermined time in the received electronic mail display state.

10. A portable data terminal having functions of transmitting and receiving electronic mails as well as displaying transmitted and received electronic mails on a display unit and storing these electronic mails in a memory unit, wherein:
the electronic mails from a designated particular electronic mail sender among the received electronic mails are displayed in a color of display different from the display color of the other electronic mails.

11. The portable data terminal according to claim 8 or 10, wherein a display state of displaying the sole electronic mails from the particular electronic mail sender is switched over from the received electronic mail display state by a predetermined operation.

12. The portable data terminal according to claim 8 or 10, wherein the serial numbers of electronic mails from the particular electronic mail sender are displayed at the same time.

13. The portable data terminal according to claim 8 or 10, wherein the sender of the electronic mail is designated with reference to an address directory, in which electronic mail addresses are stored.

14. A portable data terminal having functions of transmitting and receiving electronic mails as well as displaying transmitted and received electronic mails on a display unit and storing these electronic mails in a memory unit, wherein:
sole electronic mails to a destination of a designated particular electronic mail among the transmitted electronic mails are displayed on the display unit.

15. The portable data terminal according to claim 14, wherein the sole electronic mails to the designated particular electronic mail destination are displayed on the display unit after the lapse of a predetermined time in the transmitted electronic mail display state.

16. A portable data terminal having functions of transmitting and receiving electronic mails as well as displaying transmitted and received electronic mails on a display unit and storing these electronic mails in a memory unit, wherein:
the electronic mails to a designated particular electronic mail destination among the transmitted electronic mails are displayed in a color of display different from the display color of the other electronic mails.

17. The portable data terminal according to claim 14 or 16, wherein a display state of displaying the sole electronic mails to the particular electronic mail destination is switched over from the transmitted electronic mail display state by a predetermined operation.

18. The portable data terminal according to claim 14 or 16, wherein the serial numbers of electronic mails to the particular electronic mail destination are displayed at the same time.

19. The portable data terminal according to claim 14 or 16, wherein the destination of the electronic mail is designated with reference to an address directory, in which electronic mail addresses are stored.

20. The portable data terminal according to one of claims 1 to 19, wherein the portable data terminal is a portable telephone set.
